(19) United States
(12) Patent Application Publication
(10) Pub. No.: US 2008/0083336 A1
(43) Pub. Date: Apr. 10, 2008

(54) ELECTRICALLY CONDUCTIVE ADSORPTIVE HONEYCOMBS FOR DRYING OF AIR

(76) Inventor: Michael Ford Tschantz, Lexington, VA (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/868,123

(22) Filed: Oct. 5, 2007

Related U.S. Application Data
(60) Provisional application No. 60/828,694, filed on Oct. 9, 2006.

(51) Int. Cl. B01D 53/02

(52) U.S. Cl. 96/118

(57) ABSTRACT

A desiccant material is provided in a honeycomb structure suitable for warming by electric resistive heating to promote regeneration of the desiccant.

This non-provisional application relies on the filing date of provisional U.S. Application Ser. No. 60/828,694 filed on Oct. 9, 2006, which is incorporated herein by reference, having been filed within twelve (12) months thereof, and priority thereto is claimed under 35 USC §1.19(e).

### BACKGROUND

The use of sorption materials (sorbents) such as activated carbon to remove contaminants from air is well known. Specialized activated carbons have been developed for example as described by U.S. Pat. No. 5,538,929 which discloses a phosphorus-treated activated carbon. Sorbents may be placed within suitable air-handling systems to clean the air passing through the material. Such systems are sometimes known as vapor absorbers.

Another well known sorbent use is a desiccant for dehumidifying air. Activated carbon and other adsorbents, such as activated alumina, molecular sieves, and zeolites, have been used as desiccants to remove water vapor (humidity or moisture) from air for many years. Other types of desiccants, such as hydratable salts and silica compounds, have been used for the same purpose.

Synergistic improvements in rates of dehumidification and sorption capacities (equilibrium between vapor state and hydrated or adsorbed state of water) can often be achieved by loading high surface area adsorbents, such as activated carbon, with hydratable salts at various loading concentrations.

Activated carbon and other adsorbents function by passing humidified air through a bed containing the adsorbent. The water vapors in the air adsorb onto the carbon to achieve a partitioning ratio governed by the temperature, maximum absolute humidity, and the characteristics of the specific adsorbent. The addition of hydratable salts or silicas will affect the partitioning ratio.

The rate at which air dehumidifies is governed by factors including the absolute humidity (partial pressure of water vapor in the air), the temperature, the air velocity through the bed, the volume or mass of adsorbent, the open channel or bulk void diameter, characteristics of the adsorbent (particle size and porosity), and characteristics of the carrier media (thickness, porosity) if the adsorbing materials are distributed through some other substrate.

While air is being dried, heat is generated within the desiccant, with the heat generated being greater than the heat of condensation and/or heat of hydration of the salt employed.

Once moisture is adsorbed onto an adsorbent and/or the salts are hydrated, a desiccant may be regenerated by the addition of heat. Regeneration of the desiccant (adsorbent and/or salt), requires supplying an amount of heat greater than the heat evolved during dehumidification. The requisite heating has traditionally been applied by oven-drying the desiccant, or by passing hot air over or through the desiccant, or supplying heat from a hot liquid that is physically separated from the adsorbent by way of a non-permeable or semi-permeable barrier.

### SUMMARY

The invention disclosed here regenerates a desiccant by heating it through electric resistive heating. An electric current is passed through either the desiccant itself or through a support media in or on which the desiccant is contained.

A structural form in which activated carbon desiccant may be provided is a carbon or ceramic-carbon honeycomb. Other desiccants, or substrates containing or supporting desiccants, may also be provided in honeycomb form.

A carbon honeycomb may be formed from a ceramic-carbon mixture that is processed to form a ceramic cylindrical shape with a honeycomb-like internal cellular structure. Typically the shape has a thick exterior skin for structural integrity.

### BRIEF DESCRIPTION OF THE DRAWINGS

FIG. 1 illustrates a cutaway view of a canister device containing a desiccant honeycomb,

FIG. 2 illustrates a desiccant honeycomb, and

FIG. 3 illustrates methods of providing an electric current to desiccant honeycombs.

### DETAILED DESCRIPTION

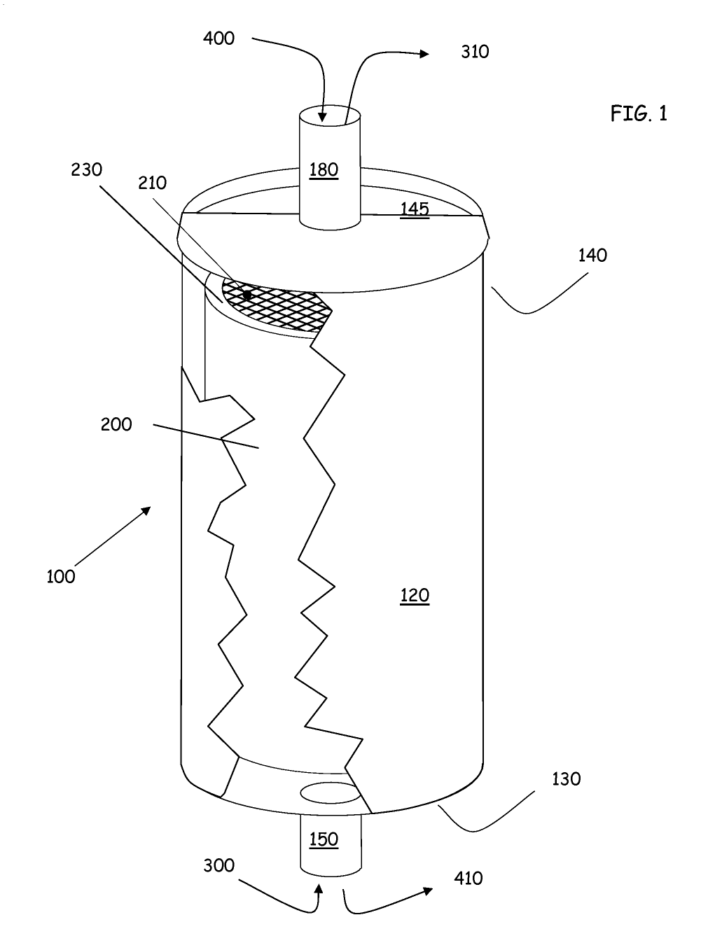

FIG. 1 illustrates a cutaway view of a canister 100 containing a desiccant honeycomb 200. Canister 100 has a wall 120 (shown in cutaway), a bottom or first end 130, and a top or second end 140, shown here with a cap or closure 145. In an example use, influent humid air stream 300 may enter canister 100 through inlet pipe 150, travel through and be dried by the desiccant honeycomb 200, then leave through outlet pipe 180 as effluent dried air stream 310. If a room or building is being dehumidified, then influent humid air stream 300 may come from the room, typically under motive force from a fan or blower (not shown). Effluent dried air stream 310 may be returned to the room.

In order to regenerate desiccant honeycomb 200, a dry purge air stream 400, (preferably relatively dry), may be passed through desiccant honeycomb 200, picking up moisture from the honeycomb, and leaving as less dry purge air stream 410. The flow of the dry purge air stream 400 in FIG. 1 is shown being countercurrent (reverse direction) to the flow of influent humid air stream 300. Depending on the system design, for example piping and valving arrangements connected to the canister, the flow might also be concurrent (same direction). The dry purge air stream 400 might be provided for example from outside a building, and the less dry purge air stream 410 may be vented back outside. However, if it is desired to recover the moisture from the less dry purge air stream 410, then it may be further processed.

The canister 100 and desiccant honeycomb 200 are shown as round cylinders as may be typical, but other shapes could also be used such as rectangular cylinders, which for example may provide geometric advantages when implementing resistive heating. The terms bottom and top (or lower and upper) are used for descriptive purposes here, as the canister may be used in any orientation. Also “influent” and “effluent” are used to describe flow through the canister, but the canister may be designed so it may be placed in a dehumidification system so that either end could be used for the “influent” or “effluent.”

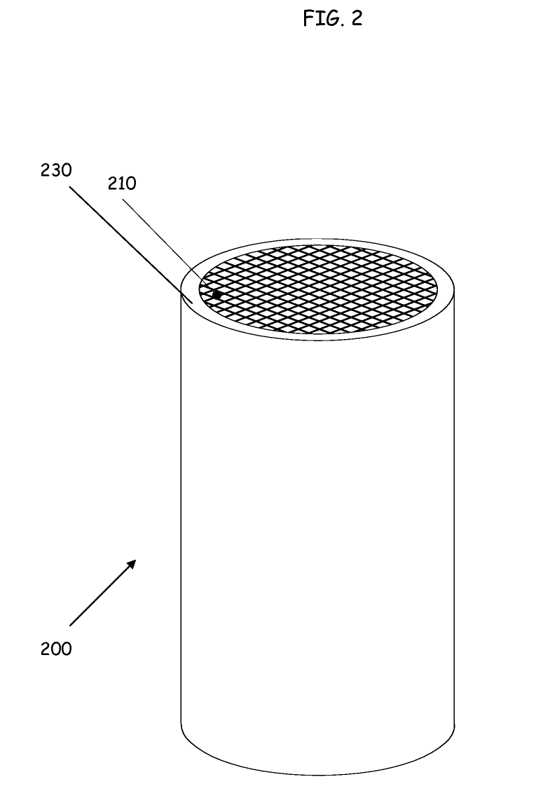

FIG. 2 illustrates a desiccant honeycomb 200, having passages 210 within the honeycomb. Passages 210 are relatively small, for example about 200 openings per square inch, and have thin walls, thus providing a high surface area for absorbing or adsorbing moisture from the air stream. The exterior wall 230 of desiccant honeycomb 200 may be somewhat thicker in order to provide structural strength.

In one embodiment, the invention comprises an electrically conductive activated carbon honeycomb. In a second embodiment, an electrically conductive activated carbon honeycomb is impregnated with a hydratable salt. In a third embodiment, a honeycomb comprises a non-carbon adsorbent such as activated alumina and/or zeolites, which might otherwise might be nonconductive, but to which carbon black is added as an electrical conductor. Combinations of these embodiments may be used.

In each of these embodiments, air is dried or dehumidified by its passage through the honeycomb, in which moisture is adsorbed onto the desiccant, whether it be activated carbon, a hydratable salt, activated alumina, zeolites, or other desiccant. The desiccant may then be regenerated (itself dried) by passing an electrical current is passed through the honeycomb, which causes the honeycomb to heat by way of resistance heating. The heat is used to evaporate adsorbed moisture from the honeycomb such that it passes out of the honeycomb by the increased partial pressure from heating. Forced convention such as an air purge stream may be used to assist in carrying away moisture during regeneration.

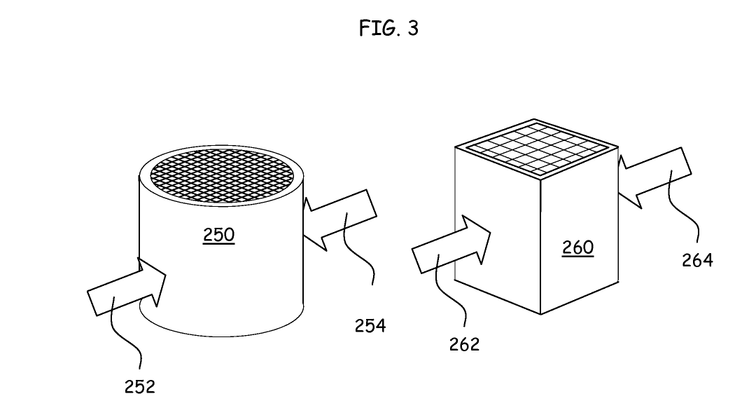

FIG. 3 illustrates methods for conducting an electric current to a desiccant honeycomb. For example, desiccant honeycomb 250 (which is a round cylinder) may be provided with current through electrodes shown schematically as arrows 252 and 254. Desiccant honeycomb 260 (which is a rectangular cylinder) may be provided with current through electrodes shown schematically as arrows 262 and 264.

The regeneration system for the inventive dehumidifier is simple and compact compared with other drying systems that require separate equipment to provide a hot fluid for regeneration. Another advantage is that a more concentrated purge stream may be created, than when using heated air for a purge, because less purge air may be required if the honeycomb is heated directly using resistance heating.

Methods of making and using desiccant honeycombs in accordance with the invention should be readily apparent from the mere description of the structure and its varied appearances as provided herein. No further discussion or illustration of such methods, therefore, is deemed necessary.

While preferred embodiments of the invention have been described and illustrated, it should be apparent that many modifications to the embodiments and implementations of the invention can be made without departing from the spirit or scope of the invention. Although the preferred embodiments illustrated herein have been described primarily in connection with round or square cylindrical carbon-ceramic monoliths of a size suitable for an air drying systems, these embodiments may easily be implemented in accordance with the invention in other structures having other functionalities.

It is to be understood therefore that the invention is not limited to the particular embodiments disclosed (or apparent from the disclosure) herein, but only limited by the claims appended hereto.

What is claimed is:

1. A device for use in a vapor adsorbing system, comprising a solid structure having a first exterior end surface and a second exterior end surface, and between said exterior end surfaces a longitudinal exterior surface, having between said first and second exterior end surfaces a plurality of linear passages providing interior surfaces within the solid structure, wherein said solid structure comprises a desiccant and said solid structure is characterized by having electrical conductivity in a range to produce electric resistive heating, wherein at least a portion of said electrical conductivity is provided by the presence of carbon within said solid structure, and wherein electric resistive heating is used to facilitate the removal of adsorbed water vapor from said solid structure for regeneration.

2. The device of claim 1, wherein said desiccant comprises activated carbon.

3. The device of claim 1, wherein said desiccant comprises a hydratable salt.

4. In a solid structure having a first exterior end surface and a second exterior end surface, and between said exterior end surfaces a longitudinal exterior surface and having between said first and second exterior end surfaces a plurality of linear passages providing interior surfaces within the solid structure, said solid structure comprising a desiccant having electrical conductivity in a range suitable for electric resistive heating, wherein a component from a gas passing through said linear passages is adsorbed or absorbed into or onto said solid structure, a method for regenerating said desiccant by passing an electric current through said solid structure to generate heat therein, and desorbing said component from said solid structure.

5. The method of claim 4, wherein said desiccant comprises activated carbon.

6. The method of claim 4, wherein said desiccant comprises a hydratable salt.
